(19) United States
(12) Patent Application Publication
(10) Pub. No.: US 2013/0067452 A1
(43) Pub. Date: Mar. 14, 2013

(54) MANAGEMENT SERVER, HOST DEVICE, AND APPLICATION MANAGEMENT METHOD

(71) Applicants: Tae-kyung Hwang, Suwon-si (KR); Sang-min Lee, Suwon-si (KR); Deok-hee Boo, Suwon-si (KR)

(72) Inventors: Tae-kyung Hwang, Suwon-si (KR); Sang-min Lee, Suwon-si (KR); Deok-hee Boo, Suwon-si (KR)

(73) Assignee: Samsung Electronics Co., Ltd., Suwon-si (KR)

(21) Appl. No.: 13/397,179

(22) Filed: Feb. 15, 2012

(30) Foreign Application Priority Data
Sep. 9, 2011 (KR) 2011-0092069

(51) Int. Cl. G06F 9/445; G06F 9/44; G06F 15/173

(52) U.S. Cl. 717/172; 709/223; 717/177; 717/175

(57) ABSTRACT

An application management method, computer-readable medium, server, and host device are provided. The application management method includes receiving policy information including a management policy for an application used by a host device from the management server, receiving an installation program for the application based on the policy information, and installing the installation program in the host device based on the policy information.

### CROSS-REFERENCE TO RELATED APPLICATIONS

This application is related to and claims priority to Korean Patent Application No. 2011-0092069, filed on Sep. 9, 2011, in the Korean Intellectual Property Office, the disclosure of which is incorporated herein by reference.

### BACKGROUND

1. Field

The embodiments discussed herein relate to a management server, a host device, and an application management method, and more particularly, to providing a management server capable of distributing an application to a host device without a need to generate an additional program for distributing the application and managing the application, the host device, and an application management method.

2. Description of the Related Art

Image forming apparatuses are devices for printing print data, which may be generated by a terminal device such as, for example, a computer, onto recording paper. Examples of the image forming apparatuses include a copier, a printer, a facsimile machine, and a multi-function peripheral (MFP) device into which the functions of a copier, a printer, and a facsimile machine are incorporated.

There are various applications available for controlling an image forming apparatus, and such applications may be upgraded for improving user convenience.

A business-to-business (B2B) market in which printer management solution suppliers manage printers distributed in public offices, colleges, or businesses has recently been developed. In the B2B market, printer management solution suppliers also manage applications installed in host devices. A related-art application management method will is illustrated, for example, in FIG. 1.

FIG. 1 is a diagram illustrating a related-art application management method, and particularly, a related-art method of deploying a new application.

As illustrated in FIG. 1, a printer management solution supplier may create a single software package (for example, an MSI file) for an application to be deployed (1).

The printer management solution supplier may generate a Group Policy Object (GPO) for deploying the software package (2), and may link an organizational unit (OU) and the GPO to select a target host device to which the GPO is to be applied (3).

In response to the selection of the target host device, the GPO may be applied to the target host device, and a new application may be installed in the target host device when the target host device is rebooted. For example, in a case in which the GPO is modified and is thus activated (4), the target host device may acquire a software package that is to be installed when the target host device is rebooted from a file server 30 (5). The target host device may install the new application using the acquired software package.

However, in the related-art application management method, the printer management solution supplier needs to generate a software package for an application to be deployed because of not using a typical software folder structure.

In addition, in a case in which an application is deployed using a computer setting, a new Group Policy may be applied when a host device is rebooted. However, if a software package deployed is erroneous, it may take a long time for the host device to be rebooted.

Moreover, to deploy multiple applications, a plurality of GPOs are required to be generated and linked to OUs separately, which is inconvenient.

### SUMMARY

Additional aspects and/or advantages will be set forth in part in the description which follows and, in part, will be apparent from the description, or may be learned by practice of the invention.

Exemplary embodiments of the present invention address at least the above problems and/or disadvantages and other disadvantages not described above.

The present invention provides a management server capable of easily distributing an application to a host device without the need to generate an additional program for distributing the application and managing the application, the host device, and an application management method.

According to an exemplary aspect of the present invention, an application management method of a management server is provided, which can be connected to a host device, the application management method including: generating policy information including a management policy for an application used by the host device; selecting a target host device to which the management policy is to be applied; and transmitting the policy information to the target host device.

The generating may include generating a Group Policy Object (GPO) including the policy information, and the selecting may include linking the GPO to a predefined management group and selecting a host from the predefined management group as the target host device.

The policy information may include at least one of application information on the application, a management policy for the application, and time information indicating a management time for the application, and the application information may include at least one of a name of the application, version information of the application, and an address at which an installation program for the application is stored, wherein the management policy for the target policy is for at least one of installing, deleting, and updating the application.

The generating may include generating the policy information as a template file.

The policy information may include a plurality of management policies for a plurality of applications.

The application management method may also include: storing an installation program for the application; and transmitting the installation program to the target host device.

The installation program may include a plurality of files.

According to another exemplary aspect of the present invention, an application management method of a host device is provided, which can be connected to a management server, the application management method including: receiving policy information including a management policy for an application used by the host device from the management server; receiving an installation program for the application based on the policy information; and installing the installation program in the host device based on the policy information.

The policy information may include at least one of application information on the application, a management policy for the application, and time information indicating a management time for the application, and the application information may include at least one of a name of the application, version information of the application, and an address at which an installation program for the application is stored, wherein the management policy for the target policy is for at least one of installing, deleting, and updating the application.

The installation program may include a plurality of files.

The policy information may include a plurality of management policies for a plurality of applications.

The application management method may also include recording the policy information in a register of the host device, wherein the receiving the installation program may include receiving the installing program based on the policy information present in the register of the register and the installing the installation program may include installing the installation program based on the policy information present in the register of the register.

The application management method may also include updating an application installed in the host device based on the policy information, and deleting an application installed in the host device based on the policy information.

The installing the installation program may be performed by a printer driver which is installed in the host device.

The installing the installation program may include installing the installation program in the host device at least one of at a time of receipt of the policy information, at a time when a user logs on to the host device after the receipt of the policy information, and at a time when the user logs off from the host device after the receipt of the policy information.

According to another exemplary aspect of the present invention, a management server is provided, which can be connected to a host device, the management server including: a policy management unit configured to generate policy information including a management policy for an application used by the host device; an account management unit configured to select a target host device to which the management policy is to be applied; and a communication interface unit configured to transmit the policy information to the target host device.

The policy management unit may be further configured to generate a GPO including the policy information, and the account management unit may be further configured to link the GPO to a predefined management group and select a host from the predefined management group as the target host device.

The policy information may include at least one of application information on the application, a management policy for the application, and time information indicating a management time for the application, and the application information may include at least one of a name of the application, version information of the application, and an address at which an installation program for the application is stored, wherein the management policy for the target policy is for at least one of installing, deleting, and updating the application.

The generating may include generating the policy information as a template file.

The policy information may include a plurality of management policies for a plurality of applications.

The management server may also include a storage unit configured to store an installation program for the application, wherein the communication interface unit may be further configured to transmit the installation program to the target host device upon request of the target host device.

The installation program may include a plurality of files.

According to another exemplary aspect of the present invention, there is provided a host device, which can be connected to a management server, the host device including: a communication interface unit configured to receive policy information including a management policy for an application used by the host device from the management server; and a printer driver unit configured to control the communication interface unit to receive an installation program for the application based on the policy information, wherein the printer driver unit is further configured to install the installation program in the host device based on the policy information.

The policy information may include at least one of application information on the application, a management policy for the application, and time information indicating a management time for the application, and the application information may include at least one of a name of the application, version information of the application, and an address at which an installation program for the application is stored, wherein the management policy for the target policy is for at least one of installing, deleting, and updating the application.

The installation program may include a plurality of files.

The policy information may include a plurality of management policies for a plurality of applications.

The host device may also include a control unit configured to record the policy information in a register of the host device, wherein the printer driver unit may be further configured to receive and install the installing program based on the policy information present in the register of the register.

The printer driver unit may be further configured to update an application installed in the host device based on the policy information and delete an application installed in the host device based on the policy information.

The printer driver unit may be further configured to install the installation program in the host device at least one of at a time of receipt of the policy information, at a time when a user logs on to the host device after the receipt of the policy information, and at a time when the user logs off from the host device after the receipt of the policy information.

According to another exemplary aspect of the present invention, a computer-readable recording medium is provided having recorded thereon a program for executing an application management method of a host device, the application management method including: receiving policy information including a management policy for an application used by the host device from the management server, receiving an installation program for the application based on the policy information, and installing the installation program in the host device based on the policy information.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 illustrates a related-art application management method.

FIG. 2 illustrates a management system according to an embodiment of the present invention;

FIG. 3 illustrates an exemplary management server;

FIG. 4 illustrates an exemplary host device;

FIG. 5 illustrates exemplary policy information that may be generated by an exemplary management server;

FIG. 6 illustrates exemplary policy information that may be stored in an exemplary host device;

FIGS. 7 to 16 illustrates an application distribution method according to an embodiment of the present invention;

FIGS. 17 and 18 illustrate an example of editing a registry in an exemplary host device;

FIG. 19 illustrates an application management method according to an embodiment of the present invention;

FIG. 20 illustrates an application management method, which is performed by an exemplary management server, according to an embodiment of the present invention; and

FIG. 21 illustrates an application management method, which is performed by t an exemplary host device, according to an embodiment of the present invention.

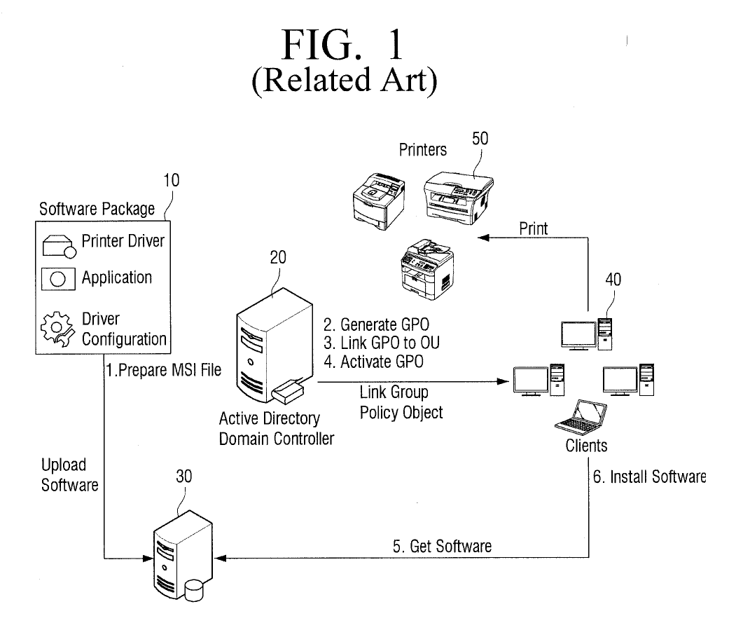

### DETAILED DESCRIPTION

Reference will now be made in detail to the embodiments, examples of which are illustrated in the accompanying drawings, wherein like reference numerals refer to the like elements throughout. The embodiments are described below to explain the present invention by as illustrated in the figures.

Exemplary embodiments of the present invention are described in greater detail with reference to the accompanying drawings.

In the following description, the same drawing reference numerals are used for the similar elements even in different drawings. The matters defined in the description, such as detailed construction and elements, are provided to assist in a comprehensive understanding of the invention.

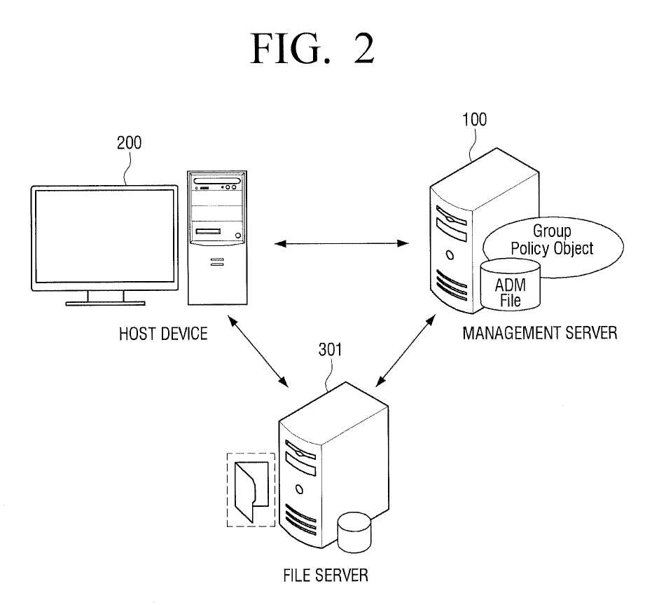

FIG. 2 illustrates a management system according to an exemplary embodiment of the present invention.

Referring to FIG. 2, a management system 1000 includes a file server 301, a management server 100, and a host device 200.

The file server 301 may store an installation program for an application. For example, the file server 301 may receive an installation program for an application from the management server 100, may store the received installation program, and may provide the stored installation program to the host device 200 upon the request of the host device 200. For example, the term “installation program” not only includes a software package, which is a type of file such as an MSI file, but also includes a software source that may be installed by executing an installation file such as a typical software folder (including a plurality of files), a compressed file (for example, a “zip” file or an “exe” file), and the like.

The management server 100 may manage the applications of a plurality of host devices. For example, the management server 100 may generate a management policy for the applications of the plurality of host devices, and may manage the plurality of host devices according to the management policy.

The host device 200 may install, update, and/or delete an application according to the management policy generated by the management server 100. For example, the host device 200 may include a printer driver (not illustrated) for installing, updating, and/or deleting an application according to the management policy generated by the management server 100, and may receive the management policy generated by the management server 100 so that one or more applications in the host device 200 may be managed by the printer driver.

In the example illustrated in FIG. 2, the management server 100 manages a single host device, i.e., the host device 200. The management server 100 may manage a plurality of host devices 200. The management server 100 may classify the plurality of host devices 200 into one or more groups and may manage the plurality of host devices 200 in units of the groups.

In the example illustrated in FIG. 2, an installation program for an application may be provided to the host device 200 by using the file server 301. An installation program for an application may be stored in the management server 100, and the management server 100 may provide the installation program to the host device 200.

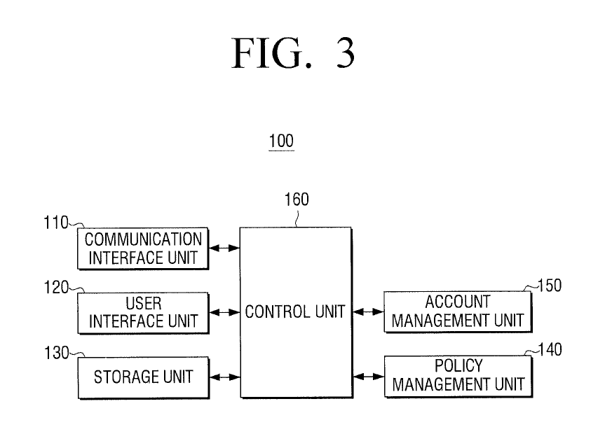

FIG. 3 illustrates a management server 100.

As illustrated in FIG. 3, the management server 100 includes a communication interface unit 110, a UI unit 120, a storage unit 130, a policy management unit 140, an account management unit 150, and a control unit 160.

The communication interface unit 110 may be connected to the host device 200 and the file server 301.

For example, the communication interface unit 110 may be provided to connect the management server 100 to an external device, and may be connected to the host device 200 and the file server 301 via a local area network (LAN) and the internet or via universal serial bus (USB) ports.

The communication interface unit 110 may transmit an installation program for an application to the management server 301. For example, the installation program may be transmitted to the host device 200 via the file server 301. For example, the installation program may be stored in a predetermined folder in the management server 100. The communication interface unit 110 may transmit the installation program to the host device 200 upon the request of the host device 200.

For example, the term “installation program” not only includes a software package, which is a type of file such as an MSI file, but also includes a software source that may be installed by executing an installation file such as a typical software folder (including a plurality of files), a compressed file (for example, a “zip” file or an “exe” file), and the like.

The communication interface unit 110 may transmit policy information to the host device 200. For example, the communication interface unit 110 may transmit policy information that is generated by the policy management unit 140 to the host device 200, which is selected by the account management unit 150.

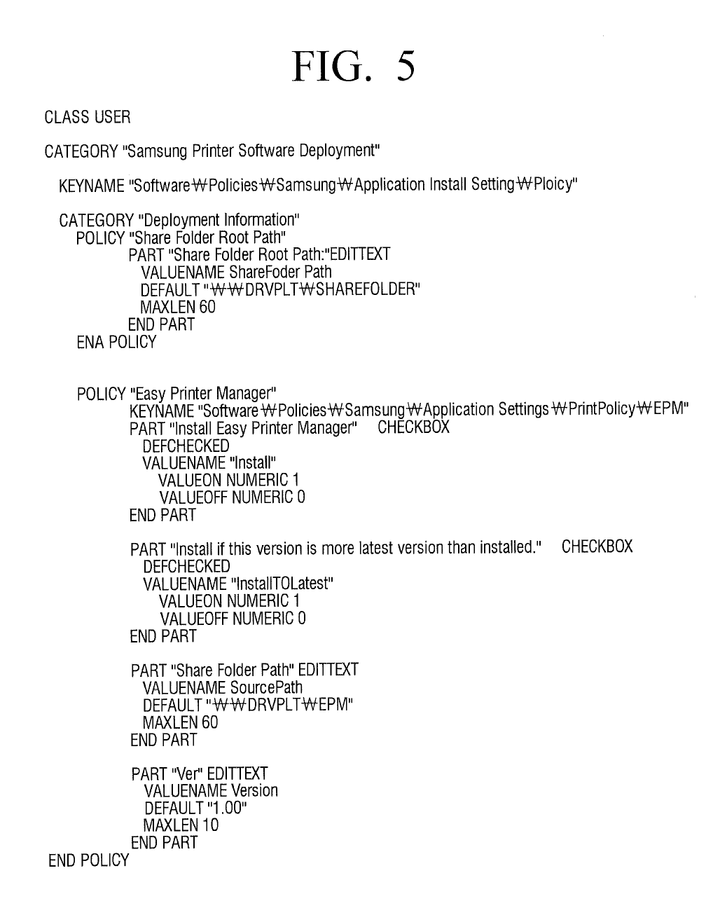

The policy information may include a management policy for a target application to be managed, which is already installed or yet to be installed in the host device 200, application information on the target application, and time information indicating a management time for the target application (for example, information indicating when to install, update, or delete the target application). An example of the policy information is illustrated in FIG. 5.

The application information may include the name of the target application, version information of the target application, and an address at which an installation program for the target application is stored, and the management policy may be a policy for indicating whether the target application has been installed, deleted, or updated.

The UI unit 120 may include a plurality of function keys that allow a user to set or select a variety of functions provided by the management server 100, and may display various information provided by the management server 100. For example, the UI unit 120 may be implemented as a device such as a touchpad capable of receiving data and outputting data, or may be implemented as a combination of a mouse and a monitor.

The UI unit 120 may receive a selection of the target application. For example, the UI unit 120 may receive a selection of a new application to be installed in the host device 200 or an existing application already installed in the host device 200 as the target application.

The UI unit 120 may also receive a selection of a management policy for the target application. For example, the UI unit 120 may receive a selection of a management policy indicating whether to install, update, or delete the target application from a manager.

The UI unit 120 may also receive a selection of a target host device (i.e., the host device 200) to which the target application and the selected management policy are to be applied. For example, the UI unit 120 may receive a selection of a management group (or an organizational unit (OU)) from among a plurality of host devices, and may receive a selection of the target host device from the management group.

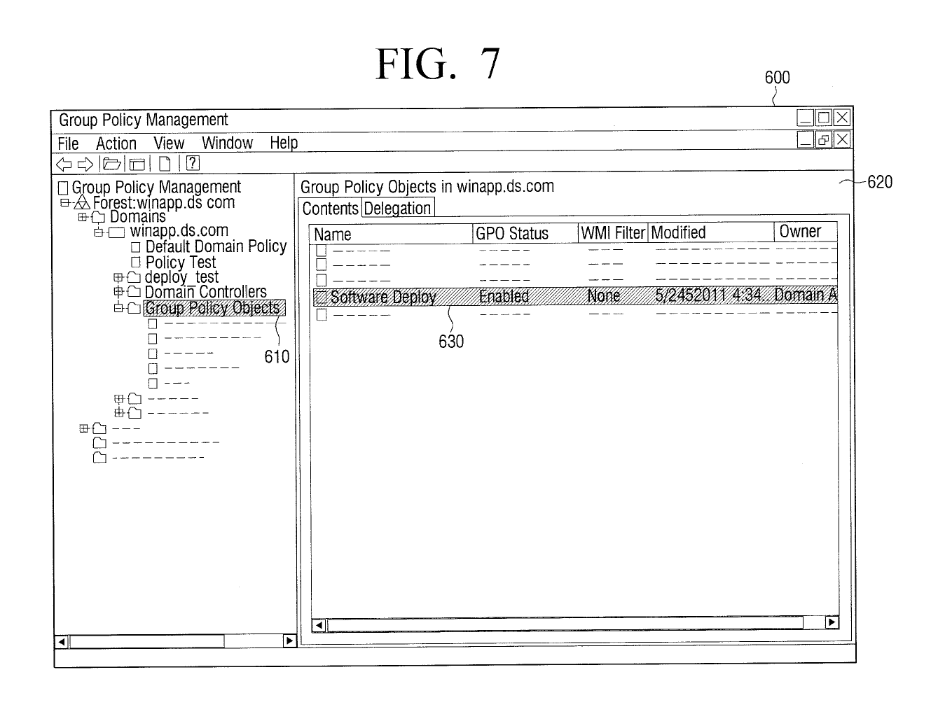

The shape and configuration of a UI window that displays the UI unit 120 to receive selections is discussed, for example, with reference to FIGS. 7 to 18.

The storage unit 130 may store policy information. For example, the storage unit 130 may store policy information that is generated by the policy management unit 140. The policy information may be generated in the format of a template file, and particularly, an administrative (ADM) template file. The policy information may include a plurality of management policies for a plurality of applications.

The storage unit 130 may store an installation program for an application. For example, the term “installation program” not only includes a software package, which is a type of file such as an MSI file, but also includes a software source that may be installed by executing an installation file such as a typical software folder (including a plurality of files), a compressed file (for example, a “zip” file or an “exe” file), and the like.

The storage unit 130 may be implemented as an internal or external storage medium, for example, a removable disk (including a USB memory), a network-based web server, or the like.

The policy management unit 140 may generate policy information including a management policy for a new application to be installed in the host device 200 or an existing application already installed in the host device 200. For example, the policy management unit 130 may generate policy information including the target application or a management policy for the target application as a template file. The template file may be an ADM template file, and the policy information may include a plurality of management policies for a plurality of applications.

The policy management unit 140 may generate a Group Policy Object (GPO) based on the generated policy information. The GPO may be a group policy for a host device or the user. For example, the term “group policy” indicates a set of computer or user settings for a user group. The GPO may be generated for each site, each domain, or each OU, or an existing GPO, if any, may be expanded by being edited. The setting of the group policy may define various elements of a user background screen environment that are needed by a system manager such as, for example, one or more programs that may be used by the user, one or more programs that may be displayed on a user background screen, start menu options, and the like. The setting of the group policy which is set by users may be included in the GPO, and may be connected to a selected Active Directory service object such as a site, domain, or an OU.

The account management unit 150 may set the target host device. For example, the account management unit 150 may link the GPO, which is generated by the policy management unit 140, to a predetermined management group (or a predetermined OU), and may select a host device from the predetermined management group as the target host device. In the example illustrated in FIG. 3, the policy management unit 140 and the account management unit 150 may be separate elements of the management server 100. The management unit 140 and the account management unit 150 may be incorporated into a single unit.

The control unit 160 may control each element of the management server 100. For example, in a case in which the user attempts to manage an application used by the host device 200, the control unit 160 may control the UI unit 120 to display a UI window for receiving selections of a management policy and the target host device, and may control the policy management unit 140 and the account management unit 150 to generate policy information and a GPO based on the selected management policy and the target host device.

In response to apply a management policy, the control unit 160 may control the communication interface unit 110 to transmit policy information including the management policy to the host device 200.

As described above, the management server 100 may provide an installation program for an application to the host device 200, without the need to generate an additional software package, to install a new application in the host device 200 or update an existing application in the host device 200. In addition, the management server 100 may manage a plurality of applications through a single setting process.

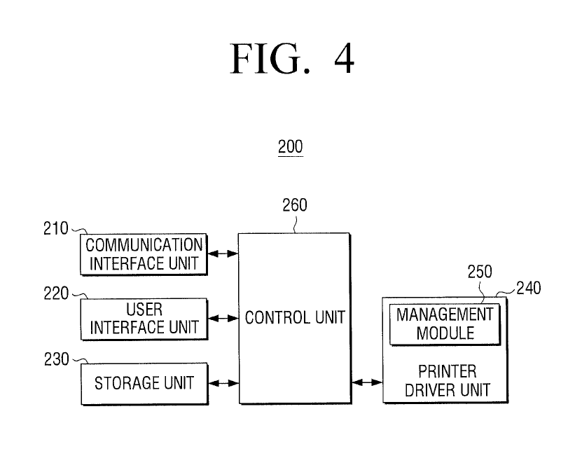

FIG. 4 illustrates a host device 200.

As illustrated in FIG. 4, the host device 200 includes a communication interface unit 210, a UI unit 220, a storage unit 230, a printer driver unit 240, and a control unit 260.

The communication interface unit 210 may be connected to the management server 100 and the file server 301. For example, the communication interface unit 210 may be provided to connect the host device 200 to an external device, and may be connected to the management server 100 and the file server 301 via a LAN and the internet or via USB ports.

The communication interface unit 210 may transmit print data associated with a print job to an image forming apparatus (not illustrated). For example, the communication interface unit 210 may transmit print data generated by the printer driver unit 240 to the image forming apparatus.

The communication interface unit 210 may receive policy information from the management server 100. The received policy information may include a management policy for a target application, which is already installed or yet to be installed in the host device 200, application information on the target application, and time information indicating a management time for the target application (for example, information indicating when to install, update, or delete the target application).

The application information may include the name of the target application, version information of the target application, and an address at which an installation program for the target application is stored, and the management policy may be a policy for indicating whether the target application has been installed, deleted, or updated.

The communication interface unit 210 may receive an installation program for the target application from the file server 301. For example, the communication interface unit 210 may issue a request for an installation program to the file server 301 based on address information included in the received policy information, and may receive the requested installation program from the file server 301.

In the example illustrated in FIG. 4, the host device 200 may receive an installation program from the file server 301. An installation program may be stored in the management server 100. The communication interface unit 210 may issue a request for the installation program to the management server 100 and may thus receive the installation program from the management server 100.

For example, the term “installation program” not only includes a software package, which is a type of file such as an MSI file, but also includes a software source that may be installed by executing an installation file such as a typical software folder (including a plurality of files), a compressed file (for example, a “zip” file or an “exe” file), and the like.

The UI unit 220 may include a plurality of function keys that allow a user to set or select a variety of functions provided by the management server 100, and may display various information provided by the management server 100. For example, the UI unit 120 may be implemented as a device such as a touchpad capable of receiving data and outputting data, or may be implemented as a combination of a mouse and a monitor.

The UI unit 220 may receive a print command. For example, the UI unit 220 may receive a selection of a file to be subject to a print job and a print command for the file from the user. In the example illustrated in FIG. 3, the UI unit 220 may receive a print command. In response to the image forming apparatus connected to the host device 200 being a multifunctional peripheral (MFP) device, the UI unit 220 may also receive a scan command, a “send fax” command, and the like.

The storage unit 230 may store the received policy information. For example, the received policy information may be recorded in a predetermined registry in the register of the host device 200, and the location of the predefined registry may be known to the management module 250.

The storage unit 230 may store the received installation program. For example, the received installation program may be a software package, which is a type of file such as an MSI file, or a software source that may be installed by executing an installation file such as a typical software folder (including a plurality of files), a compressed file (for example, a “zip” file or an “exe” file), and the like.

The storage unit 230 may be implemented as an internal or external storage medium, for example, a removable disk (including a USB memory), a network-based web server, or the like.

The printer driver unit 240 may generate print data. For example, the printer driver unit 240 may generate print data in response to the receipt of a print command via the UI unit 220, and may perform a series of processes associated with a print job.

In the example illustrated in FIG. 4, the printer driver unit 240 may perform a print job. In response to the image forming apparatus connected to the host device 200 being a multifunctional device, the printer driver unit 240 may perform a series of processes associated with a scan job, a fax job, or the like.

The printer driver unit 240 may include the management module 250, which manages the target application based on the received policy information.

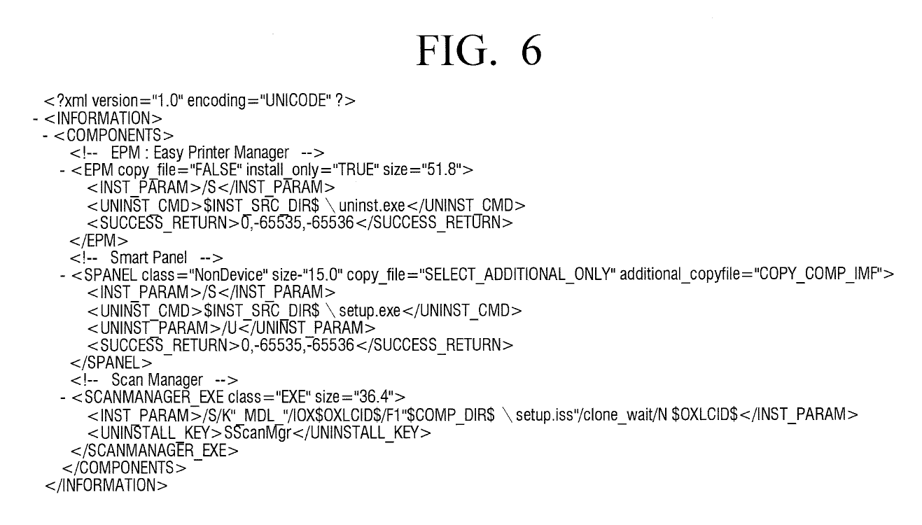

The management module 250 may execute a management policy for the target application based on the received policy information. For example, the management module 250 may access policy information present in the register of the host device 200, and may mange the target application based on the value of the corresponding register. The management module 250 may store the received policy information as an XML file. An example of an XML file that may be stored in the management module 250 is illustrated in FIG. 6. In the example illustrated in FIG. 4, the received policy information may be stored as an XML file. The received policy information may be stored as various files, other than an XML file.

In response to a management policy included in the received policy information being for installing a new application, the management module 250 may control the communication interface unit 210 to receive an installation program for the target application based on address information included in the stored XML file.

The management module 250 may control an installation program that is received at a time corresponding to a management time specified in the received policy information to be installed. For example, in response to the management time being the time of the receipt of the received policy information, the management module 250 may control an installation program that is received at the time of the receipt of the received policy information to be installed. For example, in response to the management time being the time when the user logs off from the host device 200, the management module 250 may control an installation program that is received when the user logs off from the host device 200 to be installed. For example, in response to the management time being the time when the user logs on to the host device 200, the management module 250 may control an installation program that is received when the user logs on to the host device 200 to be installed.

In response to the management policy included in the received policy information being for updating an application, the management module 250 may control the communication interface unit 210 to receive an installation program for the target application based on the address information included in the stored XML file, and may also control the target application to be updated at the management time specified in the received policy information.

In response to the management policy included in the received policy information being for deleting an application, the management module 250 may delete the target application at the management time specified in the received policy information. For example, in response to the management policy included in the received policy information being for deleting a printer driver, the management module 250 may delete an application associated with the printer driver, and may then delete the printer driver.

The control unit 260 may control each element of the host device 200. For example, in response to the receipt of policy information via the communication interface unit 210, the control unit 260 may control the received policy information to be recorded in a register of the host device 200, and may control the management module 250 to manage an application in accordance with the received policy information.

According to the example illustrated in FIG. 4, the host device 200 may receive and install an installation program regardless of whether the installation program is a software package. In addition, it is possible to install or update an installation program, not only at a time when the host device 200 is rebooted, but also at a time when the user logs on to or logs off from the host device 200 or at a time of the deployment of the installation program and thus to prevent the host device 200 from being hung due to any error that may occur during the installation of an installation program when rebooting the host device 200.

FIG. 5 illustrates exemplary policy information that may be generated, for example, by the management server 100.

As illustrated in FIG. 5, policy information may be generated as a template file according to, for example, the Microsoft specification for ADM templates. The policy information may include a plurality of management policies for a plurality of applications.

Accordingly, a manager may manage a plurality of applications using a single piece of policy information.

FIG. 6 illustrates exemplary policy information that may be stored in the host device 200.

As illustrated in FIG. 6, the printer driver unit 240 may generate an XML file based on policy information present in a predefined registry in the register of the host device 200, and may store the XML file. The XML file may include a plurality of management policies for a plurality of applications.

A management method of the management server in a case in which a new application is to be installed, for example, in the host device 200 is described with reference to FIGS. 7 to 16.

A manager may add a printer driver to be deployed on a UI 1400, which is associated with print management.

The manager may generate a GPO to be deployed along with the printer driver. For example, as illustrated in FIG. 7, Software Deploy 620 may be generated in a “Group Policy Objects” folder 610 on a UI window 600, which is associated with GPO management.

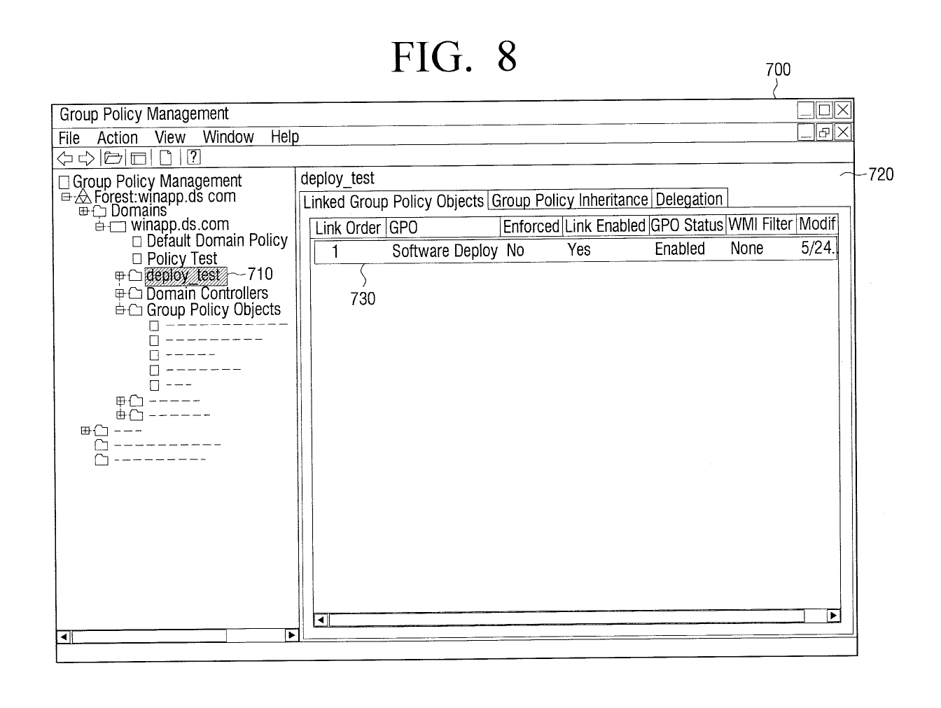

Thereafter, a target host device to which the GPO is to be applied may be selected. For example, a management group (or an OU) may be selected, and a host device may be selected from the selected management group (or the selected OU) as the target host device. As a result, as illustrated in FIG. 8, a link 730 may be configured in a “deploy_test” folder 710 on the UI window 600.

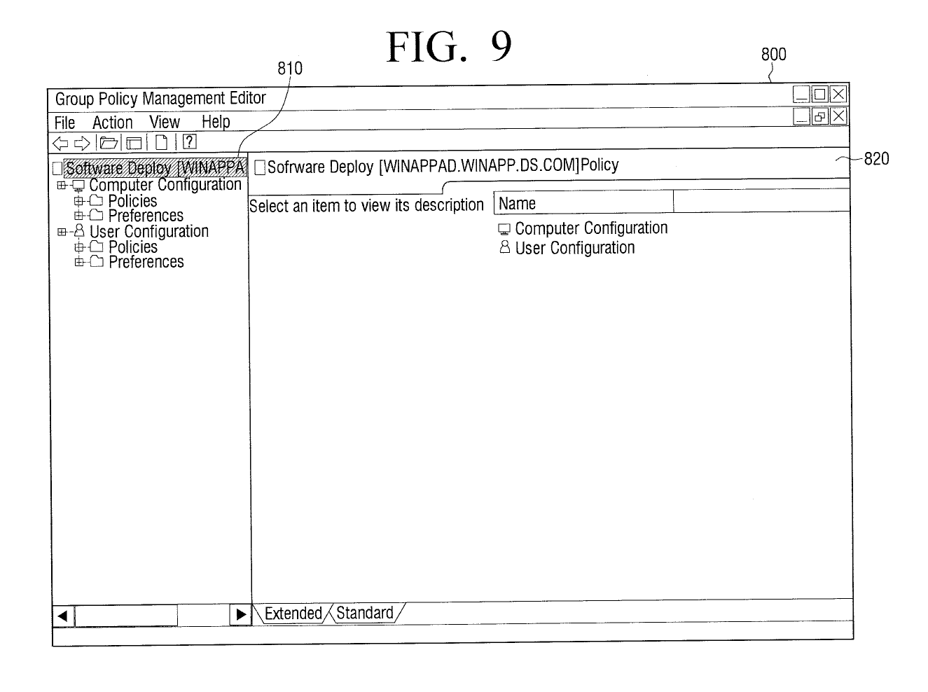

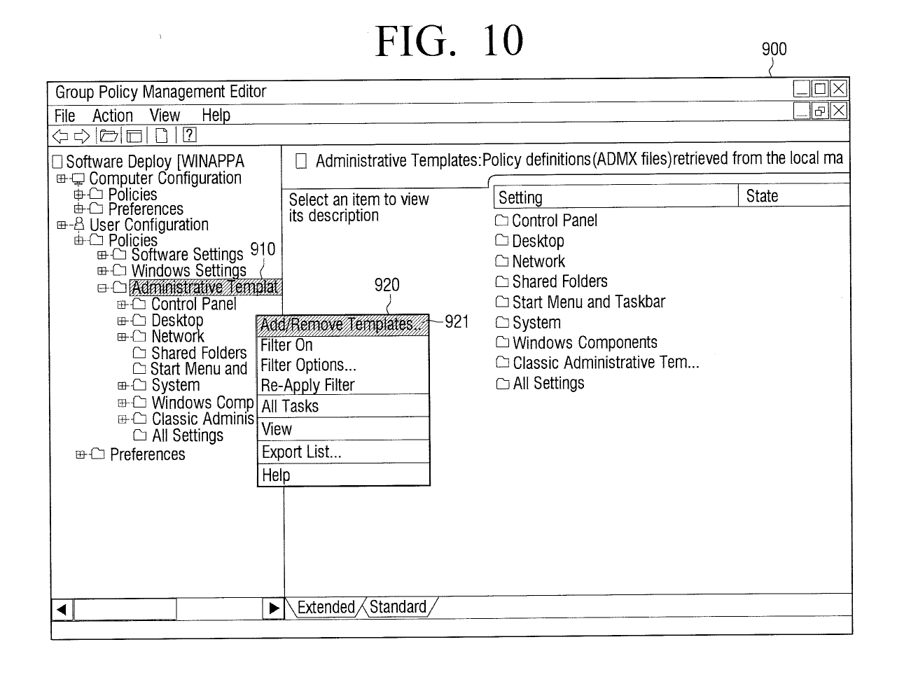

As illustrated in FIG. 9, to edit the GPO, a UI window 800, which is associated with a Group Policy Management Editor (GPME), may be displayed. In response to a “User Configuration” folder being selected from the UI window 800, a UI window 900 may be displayed, as illustrated in FIG. 10.

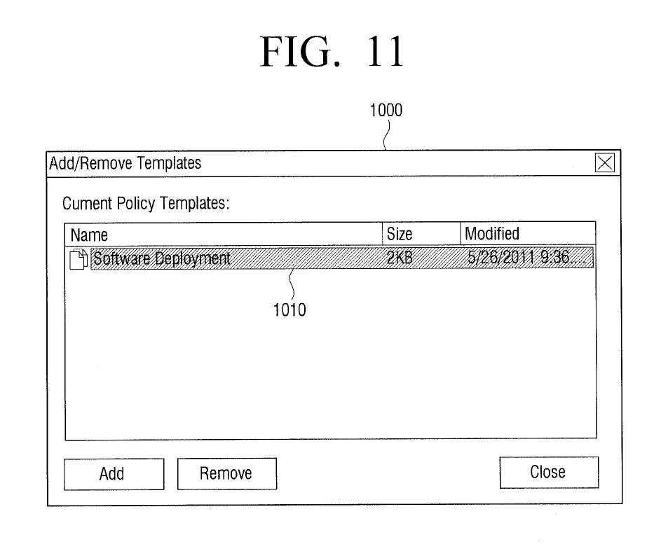

As illustrated in FIG. 10, in response to a “Administrative Template Policy” folder 910 being selected from the UI window 900 and a right click being received, a menu 920 may be displayed. Thereafter, in response to “Add/Remove Templates” 921 being selected from the menu 920 and a location 1010 at which an ADM template file exists being selected, a UI window 1000 may be displayed, as illustrated in FIG. 11.

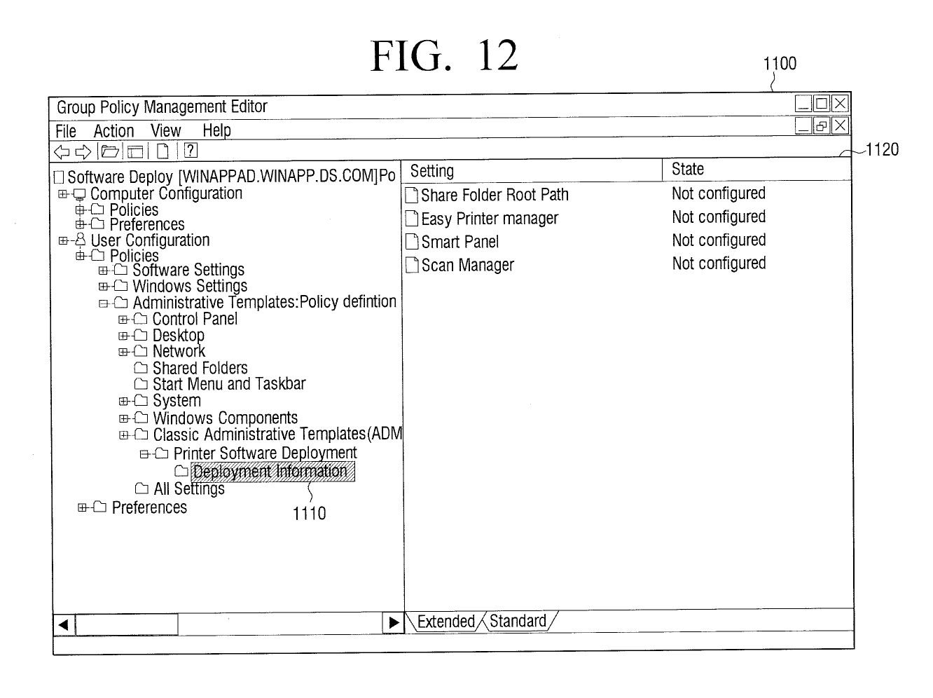

As illustrated in FIG. 12, in response to the addition of a template, deployment information for deploying software may be set. For example, as illustrated in FIG. 12, four software packages may be set in a “Setting” field 1120 as the deployment information.

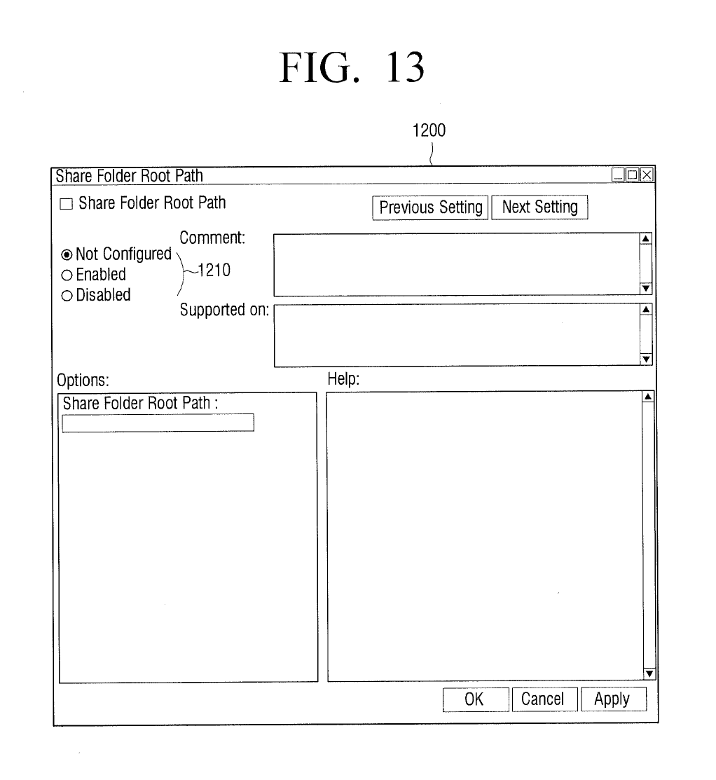

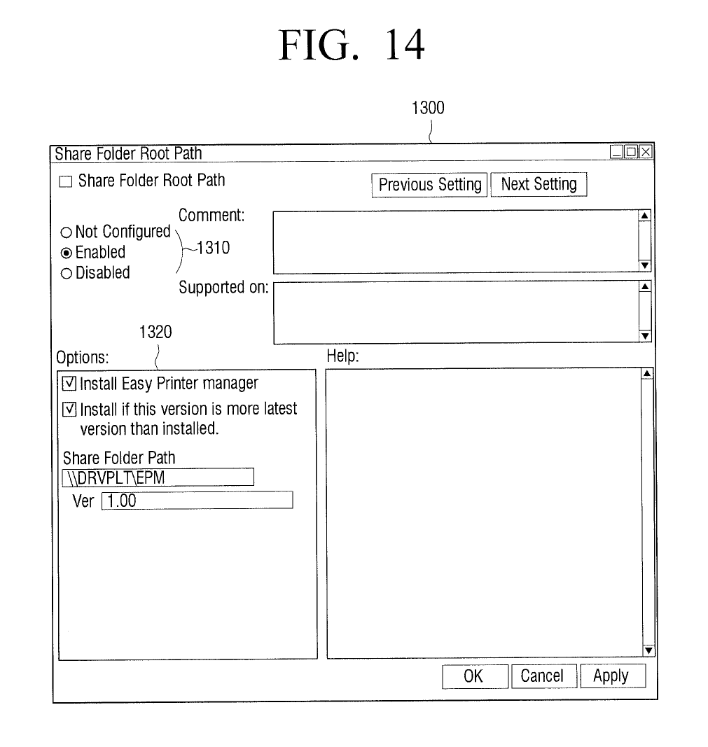

The address at which an installation program for each software is stored may be set. For example, as illustrated in FIGS. 12 and 13, in response to “share Folder Root path” being selected, a UI window 1200 may be displayed. In this example, in response to “Enabled” being selected from a “Setting” field 1210 of the UI window 1200 and the address of predetermined software being entered, a UI 1300 may be displayed, as illustrated in FIG. 14.

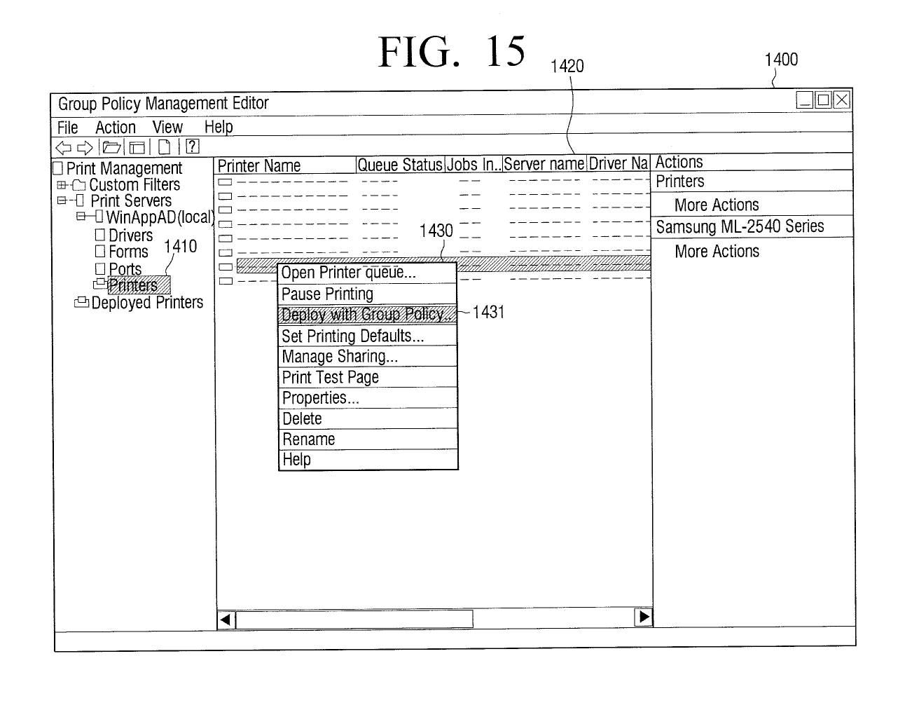

As illustrated in FIG. 15, the GPO may be connected to a printer driver to be deployed on the UI window 600, which is associated with print management.

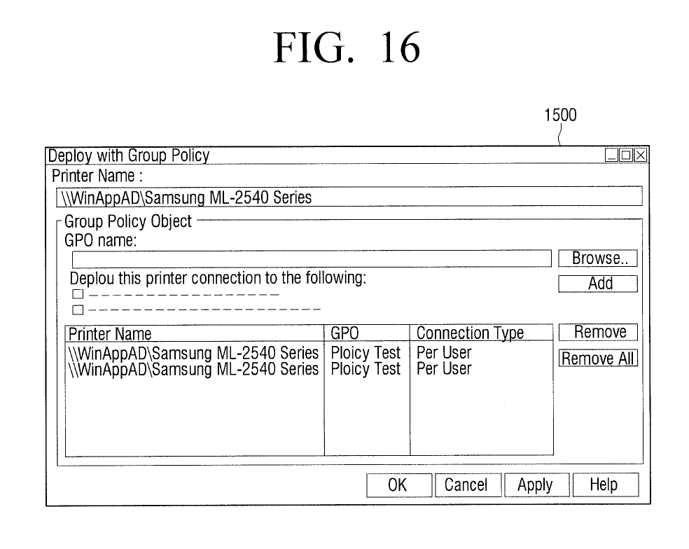

In response to the GPO being connected to the printer driver to be deployed, the setting of the installation of an application to be deployed may be considered complete, as illustrated in FIG. 16.

The management server 100 may record information regarding software deployment in a predetermined registry in the register of the host device 200. For example, the predetermined registry may correspond to “HKCU\Software\Policies.” Any registry that may be periodically accessed by the printer driver unit 240 may be used as the predetermined registry.

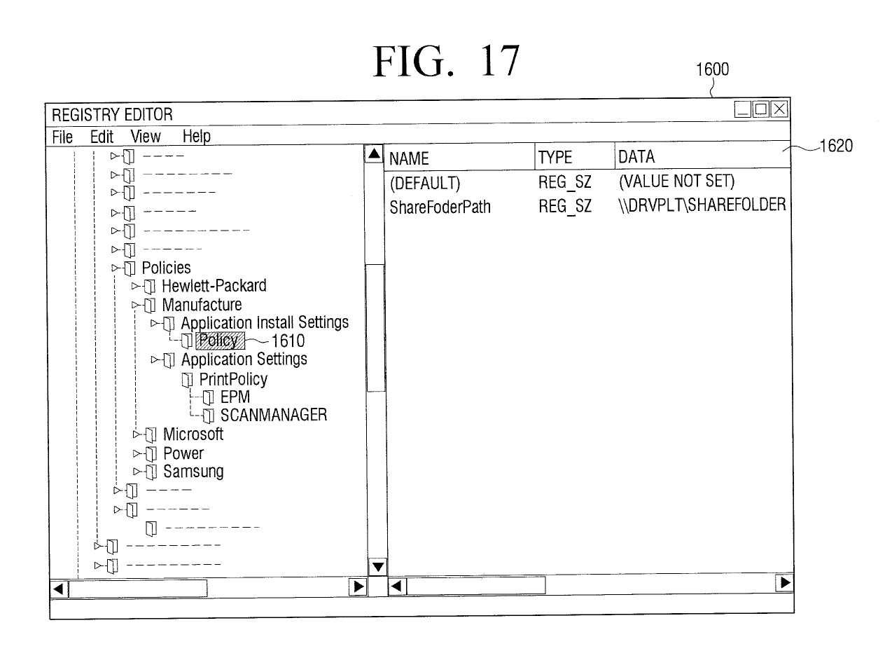

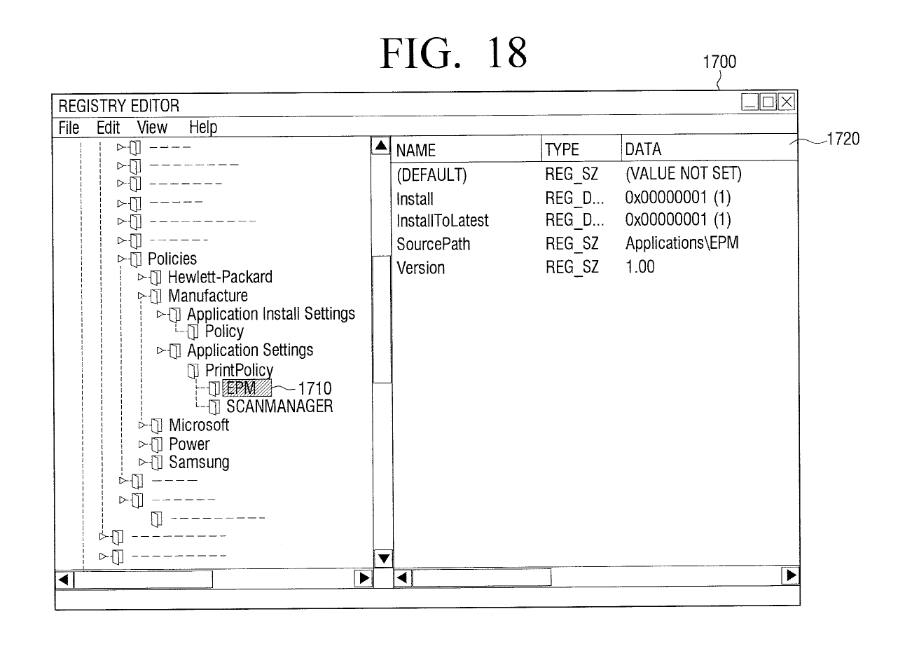

FIGS. 17 and 18 illustrate an example of editing a registry, for example, in the host device 200.

As illustrated in FIG. 17, an address 1620 of an installation program for an application to be installed may be recorded in a “Policy” folder 1610.

As illustrated in FIG. 18, information regarding the installation of an application (i.e., a management policy) may be registered in the register, for example, of the host device 200.

In response to the registration of the information regarding the installation of an application in the register of the host device 200, the printer driver unit 140 of the host device 200 may receive an installation program with reference to the information present in a predefined registry in the register of the host device 200, and may install the received installation program.

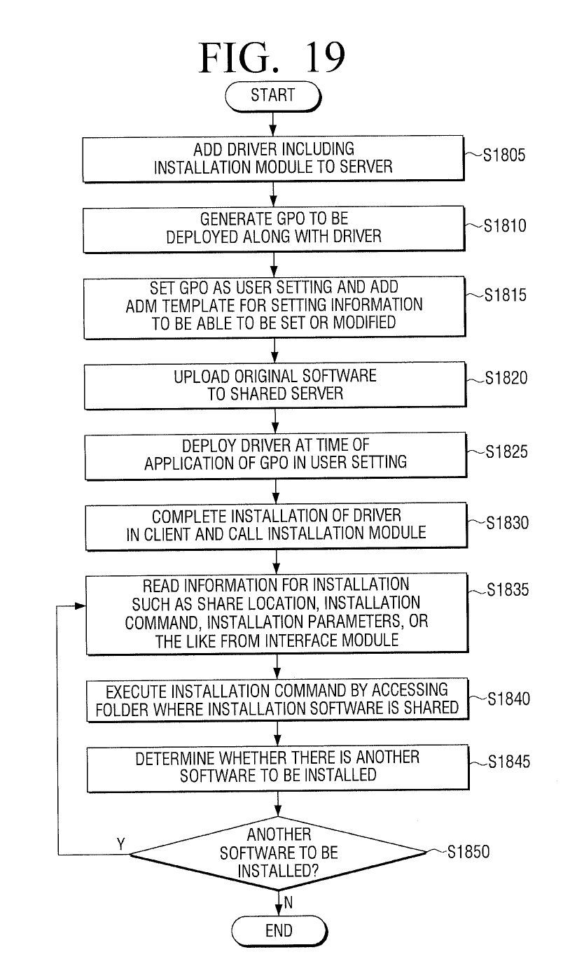

FIG. 19 is a flowchart illustrating a management method according to an embodiment of the present invention.

As illustrated in FIG. 19, the management server 100 may add an installation module (for example, a printer driver included in the management module 250 illustrated in FIG. 4 or an application) thereto (S1805), and may generate a GPO to be deployed along with the printer driver) (S1810). The management server 100 may set the GPO as a user setting, and may add policy information (i.e., an ADM template) so that installation information may be set or modified (S1815). The management server 100 may upload an installation program for the printer driver to the file server 301 (S1820).

As a result, a management policy may be activated, and a GPO setting may be applied.

The GPO setting may be recorded in the register of the host device 200. The host device 200 may call the management module 250 therein with the aid of the register thereof (S1830). In response to the management module 250 being called, the management module 250 may read out a management policy from the register of the host device 200 (S1835), may receive an installation program in accordance with the read-out management policy, and may install the received installation program in the host device 200 (S1840). In a case in which there are other more management policies for other applications, the management module 150 may also manage the other applications (S1845 and S1850).

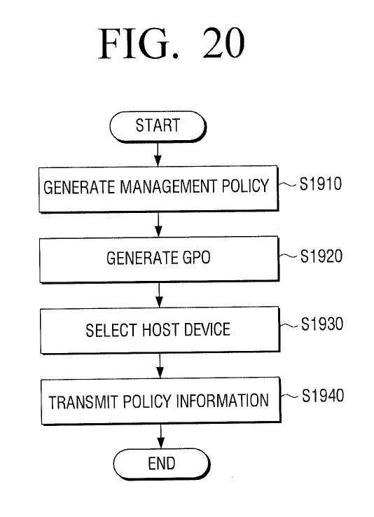

FIG. 20 is a flowchart illustrating an application management method, which is performed, for example, by the management server 100, according to an embodiment of the present invention.

As illustrated in FIG. 20, policy information including a management policy for an application used by the host device 200, i.e., a target application, may be generated (S1910). For example, policy information including the target application and a management policy for the target application may be generated as a template file such as an ADM template file. The policy information may include a plurality of management policies for a plurality of applications.

A GPO including the policy information may be generated (S1920). The GPO may be a set of group policies defined for the host device or a user.

A target host device to which the policy information is to be applied may be selected (S1930). For example, the GPO may be linked to a predefined management group, and a host device selected from the predefined management group, for example, the host device 200, may be set as the target host device.

The policy information may be transmitted to the host device 200 (S1940).

Thus, an installation program may be provided for an application without the need to generate an additional software package and thus to easily install or update the application in the host device 200. Thus, a plurality of applications may be effectively managed through a single setting process. The application management method, for example, illustrated in FIG. 20 may be performed in a management server, for example, having the structure illustrated in FIG. 3 or another structure.

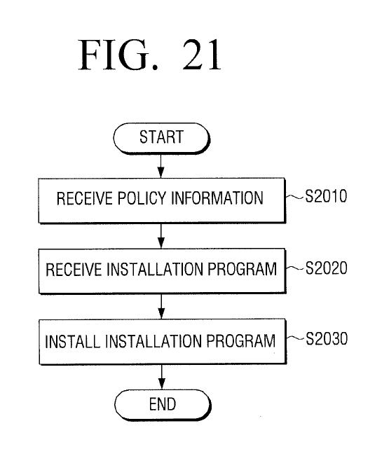

FIG. 21 illustrates an application management method, which is performed by the host device 200, according to an embodiment of the present invention.

As illustrated in FIG. 21, policy information including a management policy for an application used by the host device 200, i.e., a target application, may be received from the management server 100 (S2010). The policy information may include a management policy for the target application, which may be an existing application already installed in the host device 200 or a new application to be installed in the host device 200, information on the target application, time information indicating a management time for the target application (for example, information indicating when to install, update, or delete the target application). The policy information may be recorded in the register of the host device 200.

An installation program for the target application may be received, for example, based on the policy information (S2020). For example, in response to the management policy included in the policy information being for installing or updating the target application, the installation program for the target application may be received based on address information included in the policy information.

The received installation program may be installed, for example, in host device 200 (S2030). For example, in response to the management policy included in the policy information being for installing or updating the target application, the received installation program may be installed at the management time specified in the policy information. For example, in response to the management policy included in the policy information being for deleting the target application, the target application may be deleted at the management time specified in the policy information.

Thus, an installation program may be received and installed regardless of whether the installation program is a software package. It is possible to install or update an installation program not only at a time when the host device 200 is rebooted, but also at a time when the user logs on to or logs off from the host device 200 or at a time of the deployment of the installation program and thus to prevent the host device 200 from being hung due to any error that may occur during the installation of an installation program when rebooting the host device 200. The application management method, for example, as illustrated in FIG. 21, may be performed by a host device having the structure illustrated in FIG. 4 or another structure.

The application management method, for example, as illustrated in FIG. 21, may be implemented as at least one program that may be recorded on a computer-readable recording medium.

The processes, functions, methods, and/or software described herein may be implemented as computer-readable codes that may be written to a computer-readable recording medium. Examples of the computer-readable recording medium include devices capable of storing data in such a manner that the data may be read by a computer system.

The exemplary embodiments and advantages are merely exemplary and are not to be construed as limiting the present invention. The present teaching can be applied to other types of apparatuses. Also, the description of the exemplary embodiments of the present invention is intended to be illustrative, and not to limit the scope of the claims, and many alternatives, modifications, and variations will be apparent to those skilled in the art.

Although a few embodiments have been illustrated and described, it would be appreciated by those skilled in the art that changes may be made in these embodiments without departing from the principles and spirit of the invention, the scope of which is defined in the claims and their equivalents.

What is claimed is:

1. An application management method of a management server, which can be connected to a host device, the application management method comprising:
generating policy information including a management policy for an application used by the host device;
selecting a target host device to which the management policy is to be applied; and
transmitting the policy information to the target host device.

2. The application management method of claim 1, wherein the generating comprises generating a Group Policy Object (GPO) including the policy information, and the selecting comprises linking the GPO to a predefined management group and selecting a host from the predefined management group as the target host device.

3. The application management method of claim 1, wherein the policy information comprises at least one of application information on the application, a management policy for the application, and time information indicating a management time for the application, and the application information comprises at least one of a name of the application, version information of the application, and an address at which an installation program for the application is stored, the management policy for the target policy being for at least one of installing, deleting, and updating the application.

4. The application management method of claim 1, wherein the generating comprises generating the policy information as a template file.

5. The application management method of claim 1, wherein the policy information comprises a plurality of management policies for a plurality of applications.

6. The application management method of claim 1, further comprising:
storing an installation program for the application; and
transmitting the installation program to the target host device.

7. The application management method of claim 6, wherein the installation program comprises a plurality of files.

8. An application management method of a host device, which can be connected to a management server, the application management method comprising:
receiving policy information including a management policy for an application used by the host device from the management server;
receiving an installation program for the application based on the policy information; and
installing the installation program in the host device based on the policy information.

9. The application management method of claim 8, wherein the policy information comprises at least one of application information on the application, a management policy for the application, and time information indicating a management time for the application, and the application information comprises at least one of a name of the application, version information of the application, and an address at which an installation program for the application is stored, the management policy for the target policy being for at least one of installing, deleting, and updating the application.

10. The application management method of claim 8, wherein the installation program comprises a plurality of files.

11. The application management method of claim 8, wherein the policy information comprises a plurality of management policies for a plurality of applications.

12. The application management method of claim 8, further comprising:
recording the policy information in a register of the host device,
wherein the receiving the installation program comprises receiving the installing program based on the policy information present in the register of the register and the installing the installation program comprises installing the installation program based on the policy information present in the register of the register.

13. The application management method of claim 8, further comprising:
updating an application installed in the host device based on the policy information; and
deleting an application installed in the host device based on the policy information.

14. The application management method of claim 8, wherein the installing the installation program is performed by a printer driver which is installed in the host device.

15. The application management method of claim 8, wherein the installing the installation program comprises installing the installation program in the host device at least one of at a time of receipt of the policy information, at a time when a user logs on to the host device after the receipt of the policy information, and at a time when the user logs off from the host device after the receipt of the policy information.

16. A management server, which can be connected to a host device, the management server comprising:
a policy management unit configured to generate policy information including a management policy for an application used by the host device;
an account management unit configured to select a target host device to which the management policy is to be applied; and
a communication interface unit configured to transmit the policy information to the target host device.

17. The management server of claim 16, wherein the policy management unit is further configured to generate a GPO including the policy information, and the account management unit is further configured to link the GPO to a predefined management group and select a host from the predefined management group as the target host device.

18. The management server of claim 16, wherein the policy information comprises at least one of application information on the application, a management policy for the application, and time information indicating a management time for the application, and the application information comprises at least one of a name of the application, version information of the application, and an address at which an installation program for the application is stored, the management policy for the target policy being for at least one of installing, deleting, and updating the application.

19. The management server of claim 16, wherein the generating comprises generating the policy information as a template file.

20. The management server of claim 16, wherein the policy information comprises a plurality of management policies for a plurality of applications.

21. The management server of claim 16, further comprising:
a storage unit configured to store an installation program for the application,
wherein the communication interface unit is further configured to transmit the installation program to the target host device upon request of the target host device.

22. The management server of claim 21, wherein the installation program comprises a plurality of files.

23. A host device, which can be connected to a management server, the host device comprising:
a communication interface unit configured to receive policy information including a management policy for an application used by the host device from the management server; and
a printer driver unit configured to control the communication interface unit to receive an installation program for the application based on the policy information,
wherein the printer driver unit is further configured to install the installation program in the host device based on the policy information.

24. The host device of claim 23, wherein the policy information comprises at least one of application information on the application, a management policy for the application, and time information indicating a management time for the application, and the application information comprises at least one of a name of the application, version information of the application, and an address at which an installation program for the application is stored, the management policy for the target policy being for at least one of installing, deleting, and updating the application.

25. The host device of claim 23, wherein the installation program comprises a plurality of files.

26. The host device of claim 23, wherein the policy information comprises a plurality of management policies for a plurality of applications.

27. The host device of claim 23, further comprising:
a control unit configured to record the policy information in a register of the host device,
wherein the printer driver unit is further configured to receive and install the installing program based on the policy information present in the register of the register.

28. The host device of claim 23, wherein the printer driver unit is further configured to update an application installed in the host device based on the policy information and delete an application installed in the host device based on the policy information.

29. The host device of claim 23, wherein the printer driver unit is further configured to install the installation program in the host device at least one of at a time of receipt of the policy information, at a time when a user logs on to the host device after the receipt of the policy information, and at a time when the user logs off from the host device after the receipt of the policy information.

30. A computer-readable recording medium having recorded thereon a program for executing an application management method of a host device, the application management method comprising:
receiving policy information including a management policy for an application used by the host device from the management server;
receiving an installation program for the application based on the policy information; and
installing the installation program in the host device based on the policy information.
